(19) United States
(12) Patent Application Publication
(10) Pub. No.: US 2001/0055167 A1
(43) Pub. Date: Dec. 27, 2001

(54) Magnetic information transfer method and apparatus thereof

(76) Inventors: Nobuhide Matsuda, Osaka-fu (JP); Takashi Utsumi, Osaka-fu (JP); Masaki Kondo, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 09/838,176

(22) Filed: Apr. 20, 2001

(30) Foreign Application Priority Data
Apr. 21, 2000 (JP) 2000-120304

(51) Int. Cl. G11B 5/86

(52) U.S. Cl. 360/16

(57) ABSTRACT

A slave disk is held by a stage, and a holder holding a master disk is displaced to the side of the slave disk through use of a linear slider so that the master disk is in face-to-face contact with the slave disk. Then, vacuum suction is executed from a suction port for close contact of the stage to achieve close contact between the slave disk and the master disk. Under this close contact condition, a permanent magnet is rotated to transfer magnetic signals recorded on the master disk to the slave disk.

### BACKGROUND OF THE INVENTION

The present invention relates to a magnetic transfer method (magnetic information transfer method) for transferring pieces of record information recorded on a master disk to a magnetic disk used in hard disk devices and floppy disk devices, and to an apparatus thereof.

With advance of magnetic recording technology, magnetic recording apparatuses are gaining larger capacity or smaller size. In particular, increase of memory capacity through high-density recording of hard disk drives is remarkable.

The hard disk drive is made up of a plurality of magnetic disks, magnetic heads corresponding to each of the magnetic disks, and an electronic circuit for replay of records. In the process of manufacturing the hard disk drives, magnetic signals including format information and address information etc. are written onto a magnetic disk. Though this writing of the magnetic signals is conducted through use of magnetic heads of a hard disk drive itself, transfer using a master disk storing a record of magnetic signals such as format information and address information etc. makes it possible to perform batch-transfer of the magnetic signals to the magnetic disk serving as a slave disk. FIG. 15 shows a. constitution of a conventional apparatus which transfers magnetic signals from a master disk to a slave disk.

In FIG. 15, when a slave disk 1 is placed on a stage 3, a delivery robot 6 puts a master disk 2 on top of the slave disk 1. Under such a condition, a permanent magnet 4 is rotated one time on the master disk 2 by a motor 5. Consequently, magnetic signals recorded on the master disk 2 are magnetically transferred to the slave disk 1, by which the slave disk 1 having the magnetic signals written thereon is provided.

In the conventional apparatus, however, the master disk 2 is just put on top of the slave disk 1, so that adherence therebetween is not necessarily sufficient, which may cause irregular magnetic transfer.

In addition, though displacement for placing the master disk 2 on top of the slave disk 1 is controlled so as to have appropriate displacement speed, damages may be generated at the moment when the master disk 2 comes in contact with the slave disk 1.

Further, when the master disk 2 is detached from the slave disk 1 after termination of transfer, there may be failures in detachment attributed to close contact between the disks.

Further, the operation of matching the centers of the slave disk 1 and the master disk 2 as well as placing them in close contact to each other are conducted through mechanical positioning. Accordingly, there are such issues as low accuracy in positioning, and generation of dust due to mechanical contact.

### SUMMARY OF THE INVENTION

The present invention was invented in view of the issues of the above-stated prior art, and an object thereof is to provide a magnetic transfer method which enables smooth magnetic transfer and to provide an apparatus thereof.

In accomplishing these and other aspects, according to a first aspect of the present invention, there is provided a magnetic transfer method for performing magnetic transfer from a master disk having projections indicating information to be transferred to a slave disk with a center hole in a center thereof by placing the master disk and the slave disk in face-to-face close contact with each other,

the method comprising:

placing the master disk and the slave disk in face-to-face contact with each other;

conducting vacuum suction from the slave disk or the master disk for achieving close contact between the master disk and the slave disk facing each other;

magnetically transferring information recorded on the master disk to the slave disk; and

detaching the master disk and the slave disk after the magnetic transfer is terminated. In this invention, magnetic transfer is performed in a condition that the slave disk and the master disk are in close contact through execution of vacuum suction, which enables good magnetic transfer free from transfer irregularities.

According to a second aspect of the present invention, there is provided a magnetic transfer method as defined in the first aspect, wherein in achieving close contact between the master disk and the slave disk, vacuum suction is also conducted so as to prevent deformation of a portion of the master disk confronting the center hole of the slave disk from a surface of the master disk opposite to a surface in close contact with the slave disk. This enables to prevent deformation of a portion of the master disk confronting the center hole, caused by vacuum suction executed for achieving close contact.

According to a third aspect of the present invention, there is provided a magnetic transfer method as defined in the first aspect, wherein upon contact or detachment of the slave disk and the master disk, gas is inserted toward the master disk through the center hole of the slave disk. Consequently, inserting gas toward the master disk upon contact of the master disk and the slave disk provides a buffering effect, thereby preventing generation of damages or the like. Inserting gas toward the master disk upon detachment prevents adhesion and facilitates detachment.

According to a fourth aspect of the present invention, there is provided a magnetic transfer method as defined in the first aspect, wherein the master disk is placed in face-to-face contact with the slave disk with a buffering operation of the master disk or the slave disk. Thus, impact given at the time of contact is restricted, which enables to prevent generation of damages and the like.

According to a fifth aspect of the present invention, there is provided a magnetic transfer apparatus for performing magnetic transfer from a master disk to a slave disk with a center hole in a center thereof by placing the master disk and the slave disk in face-to-face close contact with each other, comprising:

a slave disk holding device for holding the slave disk;

a vacuum suction device for conducting vacuum suction between the master disk and the slave disk;

a master disk holding device for holding the master disk;

a forward and. backward driving device for conducting forward and backward driving of at least either the slave disk holding device or the master disk holding device in a direction of coming the master disk and the slave disk in contact with each other; and

a magnetic transfer device for transferring magnetic signals recorded on the master disk to the slave disk. This implements close contact of the master disk with the slave disk, resulting in good magnetic transfer free from transfer irregularities.

According to a sixth aspect of the present invention, there is provided a magnetic transfer apparatus as defined in the fifth aspect, wherein the -master disk holding device is provided with a suction device for vacuum-sucking a surface opposite to a surface in face-to-face contact with the slave disk. This constitution enables to prevent deformation of a portion of the master disk confronting the center hole, caused by vacuum suction executed from the center hole of the slave disk.

According to a seventh aspect of the present invention, there is provided a magnetic transfer apparatus as defined in the fifth aspect, wherein the slave disk holding device is provided with a gas insertion device for inserting gas from the center hole of the slave disk toward the master disk. Consequently, at the time of contact, a buffering effect due to gas insertion buffers impact given upon contact, thereby preventing generation of damages on a disk face. At the time of detachment, adhesion of the both disks can be prevented by the gas insertion toward the master disk from the center hole of the slave disk, which facilitates detachment.

According to an eighth aspect of the present invention, there is provided a magnetic transfer apparatus as defined in the fifth aspect, wherein the forward and backward driving device is provided with a buffering device for placing one of the master disk holding device and the slave disk holding device in face-to-face contact with the other thereof with a buffering operation. This constitution enables to restrict impact given at the time of contact and to prevent generation of damages and the like.

According to a ninth aspect of the present invention, there is provided a magnetic transfer apparatus as defined in the fifth aspect, wherein the slave disk holding device is formed to be a cylindrical shape having an inner diameter larger than a diameter of the center hole of the slave disk, and a side thereof opposite to a side holding the slave disk is blocked by a transparent object. In this constitution, image pickup of the center hole of the slave disk can be performed through the transparent object, which enables detection of deviated holding positions of the slave disk held by the slave disk holding device.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a cross sectional view showing the constitution of a magnetic transfer apparatus according to the first embodiment of the present invention;

FIG. 2 is a flow chart showing the procedure of magnetic transfer in the first embodiment;

FIG. 3 is a cross sectional view showing the constitution of a magnetic transfer apparatus according to the second embodiment of the present invention;

FIG. 4 is a flow chart showing the procedure of magnetic transfer in the second embodiment;

FIG. 5 is cross sectional view showing the constitution of a magnetic transfer apparatus according to the third embodiment of the present invention;

FIG. 6 is a flow chart showing the procedure of magnetic transfer in the third embodiment;

FIG. 7 is cross sectional view showing the constitution of a magnetic transfer apparatus according to the fourth embodiment of the present invention;

FIGS. 8A and 8B are explanatory views of a magnetic transfer of information recorded on a master disk to a slave disk in the present invention;

FIGS. 9A, 9B, 9C, 9D, and 9E are explanatory views of the magnetic transfer in the first embodiment;

FIG. 10A is a perspective view of a stage of the first embodiment;

FIG. 10B is a side view of centering operation of a slave disk to the stage of the first embodiment;

FIG. 11 is a front view of a master disk showing radially-elongated narrow grooves for vacuum suction in the first embodiment;

FIG. 12 is a side view of a magnetic transfer apparatus which can automatically supply slave disks to a master disk of an embodiment of the present invention;

FIG. 13 is a side view of a magnetic transfer apparatus according to another embodiment of the present invention;

FIG. 14 is a side view of a magnetic transfer apparatus according to another embodiment of the present invention; and

FIG. 15 is a perspective view showing the constitution of a magnetic transfer apparatus according to the prior art.

### DETAILED DESCRIPTION OF THE PREFERRED EMBODIMENTS

Before the description of the present invention proceeds, it is to be noted that like parts are designated by like reference numerals throughout the accompanying drawings. It will be understood that the following embodiments are just part of examples of the present invention and do not limit the technical range thereof.]

Present embodiments of the present invention exemplify a magnetic transfer method for implementing write of format information, address information, and the like onto a magnetic disk used in hard disk drives through magnetic transfer from a master disk storing format information, address information, and the like to the magnetic disk serving as a slave disk, as well as an apparatus thereof. The embodiments are also applicable to other magnetic transfer to magnetic disks in the same way.

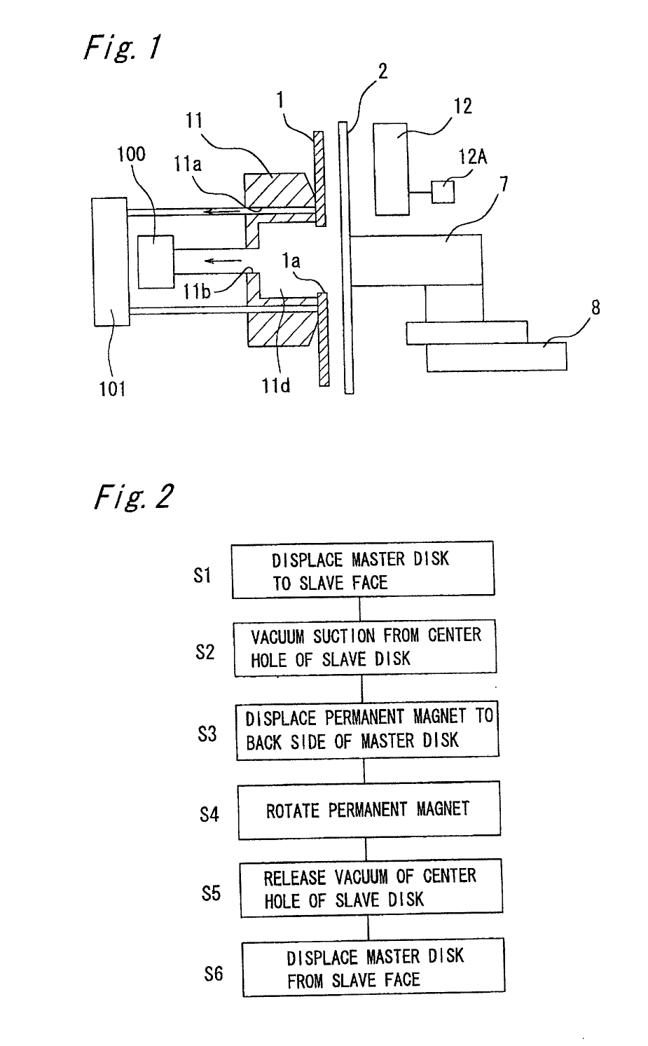

FIG. 1 shows the constitution of a magnetic transfer apparatus based on the magnetic transfer method according to the first embodiment of the present invention. The magnetic transfer method is for transferring magnetic signals from a master disk 2, for example, without a hole in a center thereof to a slave disk 1 with a center hole 1a in a center thereof by placing the master disk 2 and the slave disk 1 in face-to-face close contact with each other. In this method, the master disk 2 is moved to the side of the slave disk 1 placed in a specified position and is put in face-to-face contact with the slave disk 1. Then, vacuum suction is executed from the center hole 1a of the slave disk 1 to bring the master disk 2 facing the slave -disk 1 into close contact with the slave disk 1. Under this condition, magnetic transfer is performed from the master disk 2 to the slave disk 1.

The master disk 2 has on a substrate fine projections corresponding to information signals to be transferred to slave disk(s) 1, and has a surface with an in-planar coercive force of 40 kA/m or less and made up by hard or semi-hard ferromagnetic material having magnetism. That is, it is necessary for the master disk 2 to have such a larger coercive force that the information signals of the master disk 2 can be transferred to slave disk(s) 1. If the master disk 2 has coercive force of several hundreds kA/m, a permanent magnet 12 described later may be omitted.

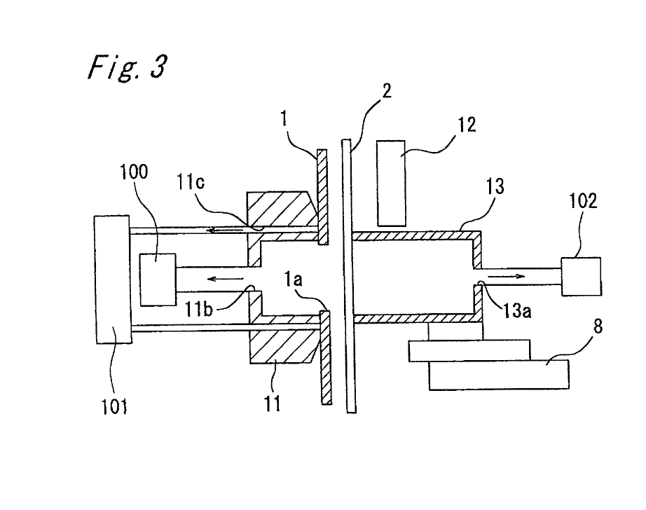

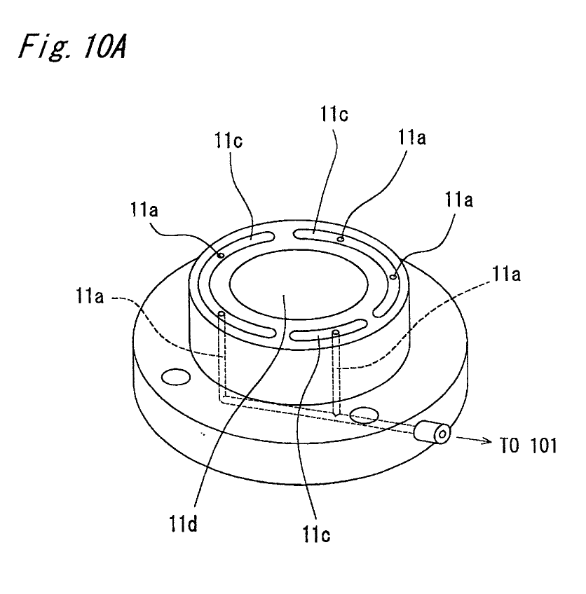

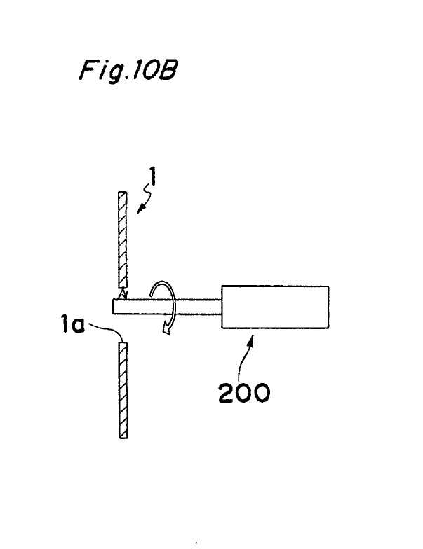

The master disk 2 is supported by a holder (serving as one example of a master disk holding device) 7 mounted on a linear slider (serving as one example of a forward and backward driving device) 8. On the back side of the master disk 2, there is provided a permanent magnet 12 in a rotatable manner in a circumferential direction of the master disk 2. The permanent magnet 12 may be replaced with an electromagnet which can change magnetic poles in FIGS. 9B and 9D described later, and also may be arranged on the slave disk side, not the master disk side as shown in FIG. 1. On the other hand, the slave disk 1 is supported by a stage (serving as one example of a slave disk holding device) 11, on the periphery of which there are formed a plurality of suction ports 11a for holding, and in the center of which there is formed a suction port 11b for close contact (vacuum suction part) interlinked to a space surrounding the center hole 1a of the slave disk 1. As shown in FIG. 10A, circular arc-shaped grooves 11c connecting to the suction ports 11a of the stage 11 are preferably formed to surely hold the slave disk 1. The stage 11 is displaced by an unshown displacement device to a specified position, where the slave disk 1 is held by the stage 11 through execution of vacuum suction (for example, at −10 kPa through −100 kPa) from the suction ports 11a for holding with use of a vacuum suction device 101, and then the moved stage 11 is displaced to the position which makes the slave disk 1 confront the master disk 2 as shown in the figure. In the condition shown in FIG. 1, magnetic signals recorded on the master disk 2 are transferred to the slave disk 1. Before the slave disk 1 is held by the stage 11 through vacuum suction, as shown in FIG. 10B, a plurality of, for example, four, inner positions of the center hole 1a of the slave disk 1 are detected by an optical probe 200 for detecting inner positions of the center hole 1a thereof by relatively moving the detection end of the probe 200 within the center hole 1a of the slave disk 1, thus executing the centering of the slave disk 1 with respect to the stage 11. This transfer operation will be described with reference to a flow chart shown in FIG. 2. It is noted that reference numerals S1, S2 . . . are step numbers indicating a sequence of the transfer operation and corresponds to reference numerals posted in description.

First, with use of the linear slider 8, the holder 7 is forwarded toward the slave disk 1, so that the master disk 2 is placed in face-to-face contact with the slave disk 1 (S1) Next, vacuum suction is executed with use of a vacuum suction device 100 connected to the suction port 11b for close contact of the stage 11. As a result, suction force reaches the master disk 2 through the center hole 1a of the slave disk 1, which puts the master disk 2 in close contact with the slave disk 1 (S2). Under the condition in which the slave disk 1 and the master disk 2 are in close contact, the permanent magnet 12 is displaced to a position close to the back side of the master disk 2 (S3), and then the permanent magnet 12 is rotated in a circumference direction of the master disk 2 through use of a rotative driving device 12A such as a motor and a rotatable plate rotated by the motor and having the permanent magnet 12 (S4). By the rotation of the permanent, magnet, magnetic signals recorded on the master disk 2 are transferred to the slave disk 1.

Upon termination of the magnetic transfer, vacuum suction from the suction port 11b for close contact is terminated (S5) to release close contact between the slave disk 1 and the master disk 2. The holder 7 is retracted by the linear slider 8 to an initial position, which detaches the master disk 2 from the slave disk 1 (S6). With the displacement of the stage 11, the slave disk 1 after the magnetic transfer is forwarded to the next step. The stage 11 then holds a next slave disk 1 to be subject to magnetic transfer, returns to the condition and position shown in FIG. 1, and then, repeats the procedure from the step S1 is repeated, for continuous execution of magnetic transfer of the slave disk 1.

When the magnetic transfer is performed in the condition that the slave disk 1 and the master disk 2 are come in close contact with each other through execution of vacuum suction, fine projections 2x of the master disk 2 and a thin magnetic layer 1 m of the slave disk 1 are in close contact to each other so as to surely transfer the magnetic transfer.

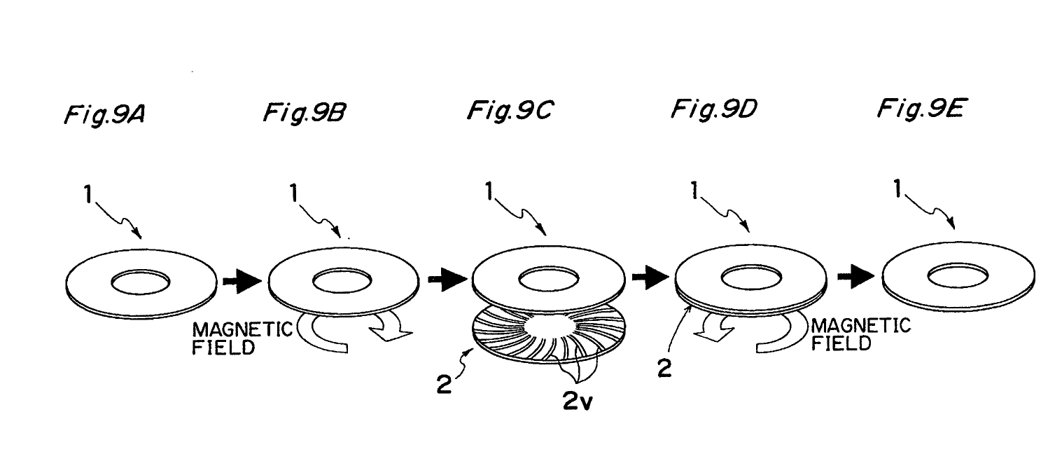

FIGS. 8A and 8B are explanatory views of a magnetic transfer of information recorded on a master disk to a slave disk. FIGS. 9A, 9B, 9C, 9D, and 9E are explanatory views of the magnetic transfer.

On the surface of the master disk 2, as shown in FIG. 9C, fine projections corresponding to information signals to be transferred to slave disks are formed in regions 2v each defined at specified angles (preferably having a circular arc shape in accordance with circular arc-movement of a reading head of an information reading device). Each surface of the projections is formed of ferromagnetic material such as Co. In each region, format information and address information etc. are recorded.

Such fine projections are formed on the surface of the master disk 2 in the following manner, for example.

First, a thin film of ferromagnetic material such as Co is formed on the surface of a glass substrate having a fine surface roughness and a good flatness which becomes the master disk 2 through sputtering process.

Next, with use of lithography process such as photolithography method using laser beam or electron beam, a resist film formed on the thin film is exposed and then developed through developing process. Thereafter, the projections are formed through dry-etching.

Alternatively, after a resist film is formed on a surface of a substrate and patterning is executed on the resist film, a ferromagnetic thin film of Co etc. is formed thereon, and then the resist film is removed from the substrate to form the projections. This method is called lift-off method.

As the method of forming the projections, for example, with use of laser beam, electron beam, or ion beam, or through mechanical process, the fine projections may be directly formed.

The method of forming the ferromagnetic thin film on a glass substrate is not limited to the sputtering process, may be a conventional thin film forming process such as vacuum evaporation process, ion-plating process, CVD process, plating process, or the like.

The distance between the top surface of each projection and the bottom surface of each recess between the fine projections corresponding to information signals is, depending on the surface characteristics of the surface of the slave disk where the master disk information is recorded and pit sizes of the master disk, generally, 0.05 μm or more, preferably 0.1 μm or more. As one example, the distance is 0.5 μm.

The ferromagnetic thin film material of the surface of the projection is not limited to Co. Many kinds of magnetic materials such as hard magnetic material, semi-hard magnetic material, or soft magnetic material may be used.

In order to generate sufficient magnetic field for recording, not depending on kinds of magnetic recording mediums to which information of the master disk is recorded, it is preferable to increase the saturated magnetic flux density of the magnetic material.

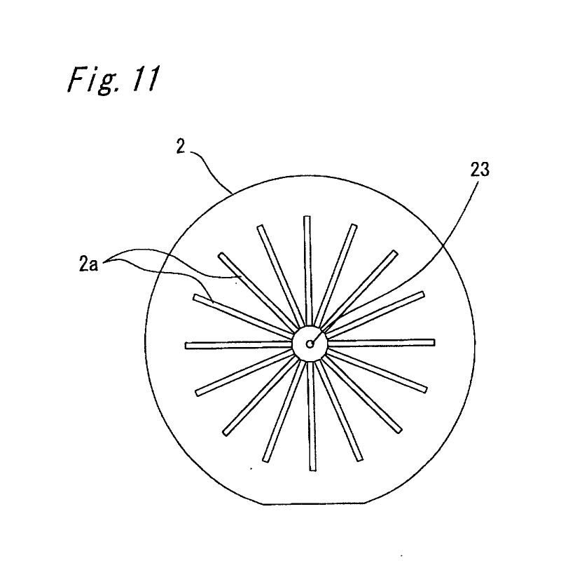

The master disk 2 has, on the surface, radially-elongated narrow grooves 2a for vacuum suction between the master disk 2 and the slave disk 1 as shown in FIG. 11. The grooves 2a are located at regions other than the regions where the information to be transferred is recorded, for example, regions where data will be stored in sectors.

After a thin magnetic layer of a slave disk of a magnetic recording material of FIG. 9A is magnetized in one direction by applying a magnetic field thereto as shown in FIG. 9B, the slave disk 1 and the master disk 2 are come in close contact with each other as shown in FIG. 9C, the magnetic field is applied from the master disk side to the slave disk side in the opposite direction to the one direction as shown in FIG. 9D. Thus, as shown in FIG. 9E, magnetic transfer (so-called pre-formating) for recording format information and address information etc. onto the slave disk 1 is terminated. As shown in FIG. 8A, When the magnetic field application is executed as shown in FIG. 8A, the fine projections 2x of the master disk 2 are come in contact with the thin magnetic layer 1m of a slave disk 1. When the thin magnetic layer 1 m of the slave disk 1 is magnetized in one direction by applying a magnetic field thereto as shown by an arrow in FIG. 9B in accordance with the rotation of a permanent magnet on a slave disk side, the all recording magnetic patterns of the slave disk l are magnetized in the one direction as indicated by arrows 1y. On the other hand, when the thin magnetic layer 1m of the slave disk 1 is magnetized in an opposite one direction by applying another magnetic field thereto as shown by an arrow in FIG. 9D in accordance with the rotation of the permanent magnet 12 having an opposite magnetic pole to the magnetic pole of the permanent magnet located on the slave disk side, every one of the all recording magnetic patterns of the slave disk 1 are magnetized in the opposite direction as indicated by arrows 1x as shown in FIG. 8B.

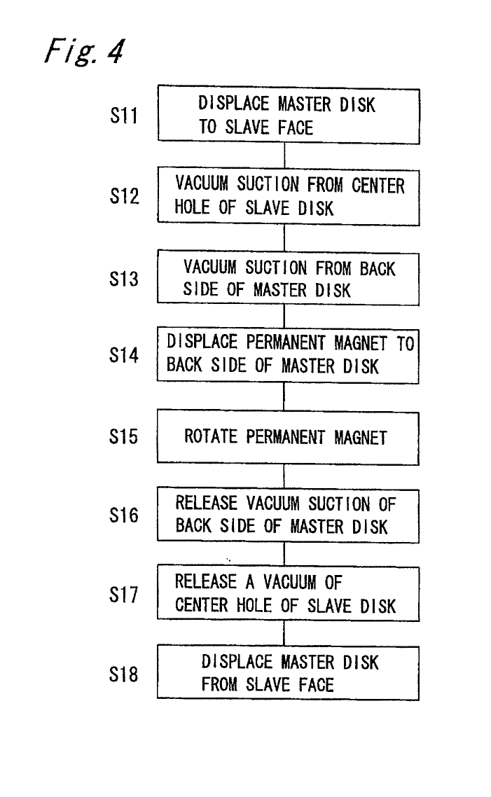

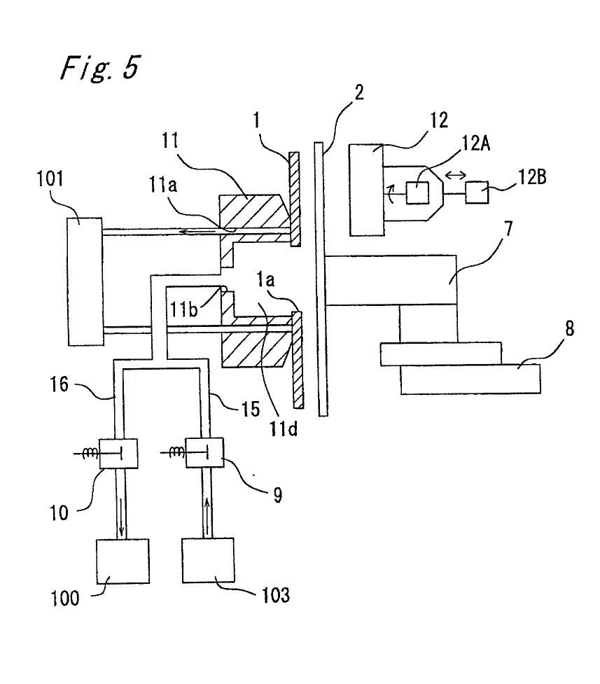

Following description is about the second embodiment of the present invention with reference to FIGS. 3 and 4. It is noted that components whose constitutions are in common with those of the first embodiment are given identical reference numerals and description thereof is abbreviated.

In FIG. 3, a holder (serving as one example of a master disk holding device) 13 for holding the master disk 2 is formed to have a hollow cylindrical shape and to execute vacuum suction by vacuum suction device 102 connected to a suction port (suction device) 13a which is interconnected to a hollow portion. This implements suction of the central portion of the master disk 2. Other constitutions are in common with the constitutions described in the first embodiment.

As described in the first embodiment, when the vacuum suction is executed from the suction port 11b for close contact provided in the stage 11, the suction force reaches the master disk 2 through the center hole 1a of the slave disk 1. It is possible that this causes deformation of a central portion of the master disk 2, which corresponds to the center hole 1a, and directly receives the vacuum suction force. However, when the central portion of the master disk 2 is sucked in an opposite direction by vacuum suction from the suction port 13a provided in the master disk holding device 13 as stated above, the deformation of the central portion of the master disk 2 can be prevented. Therefore, when the vacuum suction force from the suction port 11b for close contact and the vacuum suction force from the suction port 13a are in balance, the master disk 2 is not deformed and the magnetic transfer can be efficiently conducted.

In the case where the master disk 2 is formed with a silicon board with the thickness of 0.5 mm, without execution of vacuum suction from the suction port 13a, vacuum suction executed from the suction port 11b for close contact at 80 KPa deforms the central portion of the master disk 2, changing the height thereof to approximately 100 μm. Even if the vacuum suction is decreased to the level of 40 KPa for preventing the deformation, the central portion of the master disk 2 is deformed and the height thereof is changed to several tens μm. In order to prevent the deformation of the master disk 2, vacuum suction is required to be performed at 10 KPa or lower, which spoils sufficient adhesion to the slave disk 1. Accordingly, as shown in FIG. 3, vacuum suction from the suction port 13a, which sucks the master disk 2 from the backside thereof, enables prevention of the deformation. For example, when vacuum suction is conducted from the suction port 11b for close contact at 80 Kpa together with vacuum suction from the suction port 13a at 80 KPa, no deformation of the master disk 2 is observed, resulting in excellent magnetic transfer.

Description will be made of the procedure of transfer operation for transferring magnetic signals from the master disk 2 to the slave disk 1 based on the constitution shown in FIG. 3 with reference to FIG. 4. It is noted that like the first embodiment, the stage 11 is displaced by an unshown displacement means to a specified position, where the slave disk 1 is held by the stage 11 through execution of vacuum suction from the suction port 11a for holding, and then the stage 11 is displaced to the position which makes the slave disk 1 confront the master disk 2 as shown in the figure.

First, with use of the linear slider 8, the holder 13 is forwarded toward the slave disk 1, so that the master disk 2 is placed in face-to-face contact with the slave disk 1 (S11). Next, vacuum suction is executed with use of the vacuum suction device 100 connected to the suction port 11b for close contact. As a result, suction force reaches the master disk 2 through the center hole 1a of the slave disk 1, which puts the master disk 2 in close contact with the slave disk 1 (S12). At the same time, vacuum suction from the suction port 13a is executed, which sucks the master disk 2 from the backside thereof. Consequently, the master disk 2 comes into close contact with the slave disk 1 free from deformation of the center portion, because of the balanced suction force given to the both side of the master disk 2 (S13). Under the condition in which the slave disk 1 and the master disk 2 are in close contact, the permanent magnet 12 is displaced to a position close to the back side of the master disk 2 (S14), and then the permanent magnet 12 is rotated in a circumference direction of the master disk 2 around the center of the master disk 2 through use of the rotative driving device 12A, by which magnetic signals recorded on the master disk 2 are transferred to the slave disk 1 (S15)

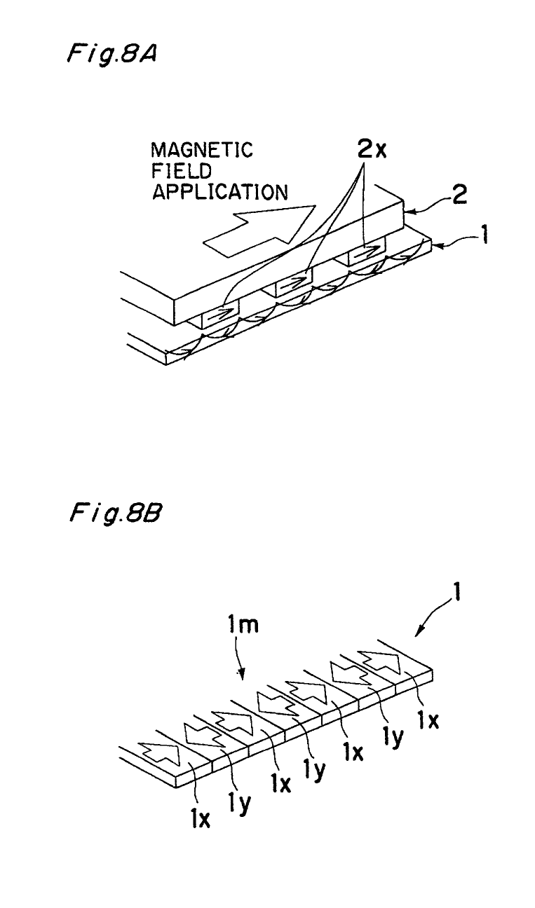

Upon termination of the magnetic transfer, vacuum suction from the suction port 13a is terminated (S16), while at the same time, vacuum suction from the suction port 11b for close contact is terminated (S17) to release close contact between the slave disk 1 and the master disk 2. The holder 7 is retracted by the linear slider 8 to an initial position, which detaches the master disk 2 from the slave disk 1 (S18). With the displacement of the stage 11, the slave disk 1 after the magnetic transfer is forwarded to the next step. The stage 11 then holds a next slave disk 1 to be subject to magnetic transfer, returns to the condition and position shown in FIG. 7, and repeats the procedure from the step S11, for continuous execution of magnetic transfer of the slave disk 1.

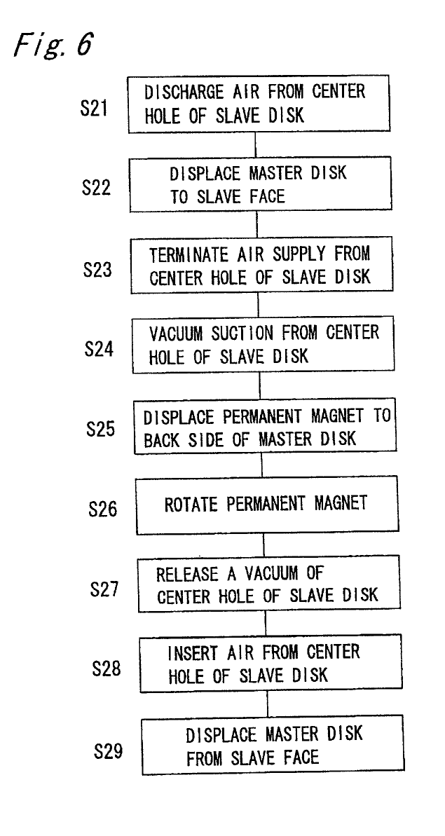

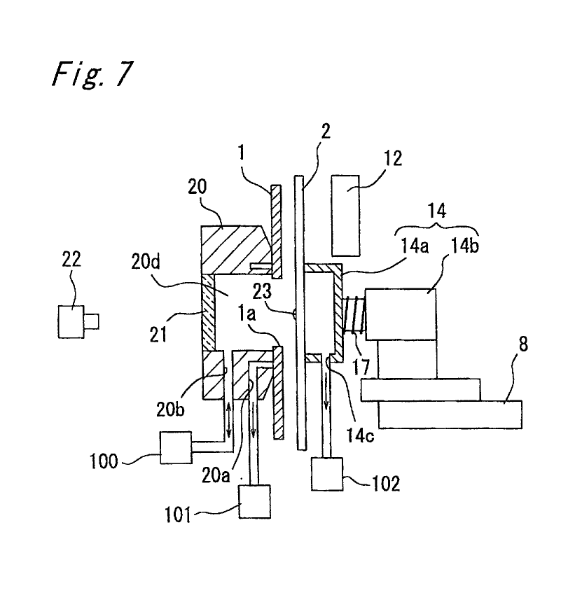

Next description is about the third embodiment of the present invention with reference to FIGS. 5 and 6. It is noted that components whose constitutions are in common with those of the first and second embodiments are given identical reference numerals and description thereof is abbreviated.

In FIG. 5, an air supply line 15 coming from an air supply device 103 and an air suction line 16 coming from the vacuum suction device 100 are connected to the suction port 11b for close contact of the stage 11 supporting the slave disk 1. The supply line 15 is equipped with a pneumatic solenoid-controlled valve 9 for opening and closing the air supply line 15, while the suction line 16 is equipped with a vacuum solenoid-controlled valve 10 for opening and closing the air suction line 16. The holder 7 for holding the master disk 2 shares the constitution with the first embodiment, though the holder 13 provided with the vacuum suction device 102 shown in the second embodiment is also applicable to the third embodiment.

The procedure of magnetic transfer with use of a magnetic transfer apparatus according to the above constitution will be described with reference to FIG. 6. It is noted that like the first embodiment, the stage 11 is displaced by an unshown displacement device to a specified position, where the slave disk 1 is held by the stage 11 through execution of vacuum suction from the suction port 11a for holding, and then the stage 11 is displaced to the position which makes the slave disk 1 confront the master disk 2 as shown in the figure.

First, the pneumatic solenoid-controlled valve 9 is opened so that air is being supplied from the supply line 15 to the stage 11, and inserted from the center hole 1a of the held slave disk 1 toward the master disk 2 through an inner space 11d of the stage 11 (S21). Next, with use of the linear slider 8, the holder 7 is forwarded toward the slave disk 1, so that the master disk 2 is placed in face-to-face contact with the slave disk 1 (S22). Here, air being inserted from the center hole 1a of the slave disk 1 toward the master disk 2 generates a buffering effect upon contact of the master disk 2, thereby preventing damages on the confronting surfaces of the slave disk 1 and the master disk 2.

When the master disk 2 comes into contact with the slave disk 1, the pneumatic solenoid-controlled valve 9 is closed (S23), and the vacuum solenoid-controlled valve 10 is opened to execute vacuum suction from the vacuum suction device 100 through the suction line 16. As a result, suction force reaches the master disk 2 through the center hole 1a of the slave disk 1, which puts the master disk 2 in close contact with the slave disk 1 (S24). Under the condition in which the slave disk 1 and the master disk 2 are in close contact, the permanent magnet 12 is displaced to a position close to the back side of the master disk 2 by a moving device 12B such as a cylinder (S25), and then the permanent magnet 12 is rotated in a circumference direction of the master disk 2 through use of the rotative driving device 12A (S26). By the rotation of the permanent magnet 12, magnetic signals recorded on the master disk 2 are transferred to the slave disk 1.

Upon termination of the magnetic transfer, the vacuum solenoid-controlled valve 10 is closed to terminate vacuum suction from the suction port 11b for close contact (S27). Then, the pneumatic solenoid-controlled valve 9 is opened for air supply, by which air is inserted from the center hole 1a of the slave disk 1 toward the master disk 2 (S28) to facilitate detachment of the slave disk 1 and the master disk 2. When the holder 7 is retracted by the linear slider 8, the inserted air releases close contact between the master disk 2 and the slave disk 1. This prevents adhesion of the slave disk 1 to the master disk 2 and prevents deformation, enabling detachment without damages to the master disk 2.

Retraction of the holder 7 returns the master disk 2 to an initial position, which detaches the master disk 2 from the slave disk 1 (S29). With the displacement of the stage 11, the slave disk 1 after the magnetic transfer is forwarded to the next step. The stage 11 then holds a next slave disk 1 to be subject to magnetic transfer, returns to the condition and position shown in FIG. 5, and repeats the procedure from the step S1, for continuous execution of magnetic transfer of the slave disk 1.

Next, description will be made of the fourth embodiment of the present invention with reference to FIG. 7. It is noted that components whose constitutions are in common with those of the second embodiment are given identical reference numerals and description thereof is abbreviated.

As shown in FIG. 7, a holder (serving as one example of a master disk holding device) 14 is equipped with a buffering structure (serving as one example of a buffering device) 17, which prevents generation of damages when the holder 14 is displaced toward the side of the slave disk 1 by the linear slider 8 to put the master disk 2 in face-to-face contact with the slave disk 1. The buffering structure 17 may be, for example, composed of a spring placed in between a front end portion 14a of the holder 14 for holding the master disk 2 and a rear end portion 14b fixed to the linear slider 8 so as to displace the front end portion 14a toward the rear end portion 14b in an axis direction by an urging force of the spring.

To increase productivity, displacement of the holder 14 by the linear slider 8 is set to be executed at a speed of approximately 10 mm/sec. With this level of displacement speed, impact generated at the time when the master disk 2 comes in contact with the slave disk 1 is considerably large, which may cause damages on the master disk 2 or the slave disk 1. However, the presence of the buffering structure 17 buffers the impact, thereby preventing generation of damages.

Although, the holder 14 equipped with the buffering structure 17 is applicable to the constitution shown in the first embodiment, it is preferable to apply it to the constitution depicted in the second embodiment as shown in FIG. 7.

In FIG. 7, the front end portion 14a of the holder 14 for holding the master disk 2 is formed to have a hollow cylindrical shape. In this constitution, vacuum suction is executed by a vacuum suction device 102 connected to a suction port 14c which is interconnected to the hollow cylindrical front-end portion 14a. This implements suction of the central portion of the master disk 2. In addition, a stage (serving as one example of a slave disk holding device) 20 holds the slave disk 1 through execution of vacuum suction from a suction port 20a for suction-holding. When displacement of the stage 20 brings the slave disk 1 to a position to confront the master disk 2, the master disk 2 is placed in face-to-face contact with the slave disk 1 by the holder 14 displaced by forwarding movement of the linear slider 8. Here, the buffering structure 17 imparted to the holder 14 buffers impact upon contact, thereby preventing damages given to the master disk 2 or the slave disk 1. Further, if the master disk 2 is put in contact with the slave disk 1 under the condition in which air is being inserted from a suction port 20b for close contact provided in the stage 20 toward the master disk 2 via an inner space 20d of the stage 20 and the center hole 1a of the slave disk 1 as described before, impact given upon contact is more efficiently buffered by the effect of the buffering structure 17 combined with a buffering effect due to air insertion. This ensures prevention of damages given to the master disk 2 or the slave disk 1 when they come in contact with each other.

Upon face-to-face contact of the master disk 2 with the slave disk 1, if the vacuum suction from the suction port 20b for close contact provided in the stage 20 is selected, the suction force reaches the master disk 2 through the center hole 1a of the slave disk 1, which puts the slave disk 1 and the master disk 2 in close contact. This may cause deformation of a central portion of the master disk 2 which corresponds to the center hole la and directly receives the vacuum suction force. However, vacuum suction from the suction port 14c provided in the holder 14 prevents the deformation of the central portion of the master disk 2 by sucking the master disk 2 in an opposite direction. Therefore, if the vacuum suction force from the suction port 20b for close contact and the vacuum suction force from the suction port 14c are in balance, the master disk 2 is not deformed and magnetic transfer can be efficiently conducted.

It will be understood that the procedure of magnetic transfer in the constitution of the present embodiment is identical to that of the second embodiment, so that description thereof is abbreviated.

In addition, as shown in FIG. 7, the rear end portion of the stage 20 is blocked by a transparent object 21. In this constitution, a camera 22 is installed in a rear end direction of the stage 20 for image pickup of the center hole 1a of the slave disk 1 through the transparent object 21. This enables to detect deviated holding positions of the slave disk 1 which is sucked and held by the stage 20. For example, as shown in FIG. 7, an alignment mark 23 is preparatorily formed on the center of the master disk 2, and image pickup of the center hole 1a and the alignment mark 23 are executed by the camera 22 through the transparent object 21, which enables to detect the deviation in the central positions of the alignment mark 23 and the center hole 1a. Accordingly, in the case where the position of the slave disk 1 held by the stage 20 is deviated from a specified position, the direction and amount of the deviation are detected, based on which the position of the stage 20 or the master disk 2 can be justified.

In each constitution described hereinbefore, the master disk 2 is displaced to the side of the slave disk 1 by the linear slider 8. However, it is also possible to fix the position of the master disk 2 and displace the slave disk 1 to the side of the master disk 2 for achieving face-to-face contact thereof.

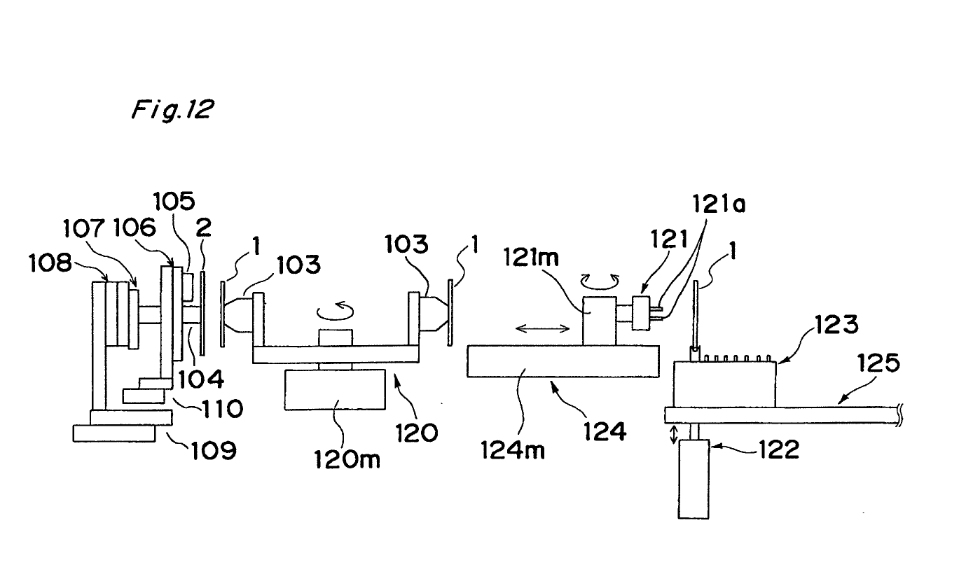

In FIG. 12, reference numeral 120 denotes a rotary indexing device, 121 denotes a handling device for slave disk, 122 denotes a slave disk lifter, 123 a slave cassette for storing a plurality of slave disks in a standing state, 124 a direct-driving motor for handling the slave disk 1, 125 a direct-driving motor for cassette. Reference numeral 103 denotes a stage (serving as one example of a slave disk holding device) corresponding to the stage 20 in FIG. 7, 104 denotes a holder (serving as one example of a master disk holding device) corresponding to the holder 14 in FIG. 7, 105 denotes a permanent magnet corresponding to the permanent magnet 105 in FIG. 7, 106 denotes a rotary motor for rotating the permanent magnet 105, 107 denotes an X-direction stage for master disk, 108 denotes a Y-direction stage for master disk, 109 denotes a linear slider for master disk, 110 denotes a linear slider for permanent magnet 105. The linear slider 110 moves the permanent magnet 105 so as to move to in a vicinity of the master disk 2 and move far from the master disk 2. For positioning the maser disk 2 with respect to the slave disk 1, the X-direction stage 107 moves the master disk 2 in an X-direction (for example, vertical direction) and the Y-direction stage 108 moves the master disk 2 in a Y-direction (for example, lateral direction) perpendicular to the X-direction. The linear slider 109 moves the master disk 2 between a position a vicinity of and a position far from the slave disk 1.

As shown in FIG. 12, the slave cassette 123 storing the plural slave disks 1 is moved to a handling position by the direct-driving motor 125. Then, one of the slave disks 1 stored in the cassette 123 is lifted up by the slave disk lifter 122 to a first handling position. As shown in FIG. 12, the slave disk 1 lifted up to the first handling position is held by the handling device 121, located at a second handling position, by inserting a pair of pins 121a of the handling device 121 into the center hole 1a of the slave disk 1 and then moving radially outwardly the pins 121a to hold the inner surface of the center hole 1a thereof. The slave disk 1 held by the handling device 121 is rotated by 180 degrees by a motor 121m of the handling device 121, and is moved from the second handling position to a first transfer position by a motor 124m of the direct-driving motor 124 for handling. The slave disk 1 at the first transfer position is transferred from the handling device 121 to the stage 103 by sucking the slave disk 1 of the handling device 121 by the stage 103 and then releasing the pins 121a of the handling device 121 from the center hole 1a of the slave disk 1. Then, the stage 103 holding the slave disk 1 is rotated by 180 degrees by a motor 120 m of the rotary indexing device 120 so as to oppose the slave disk 1 to the maser disk 2.

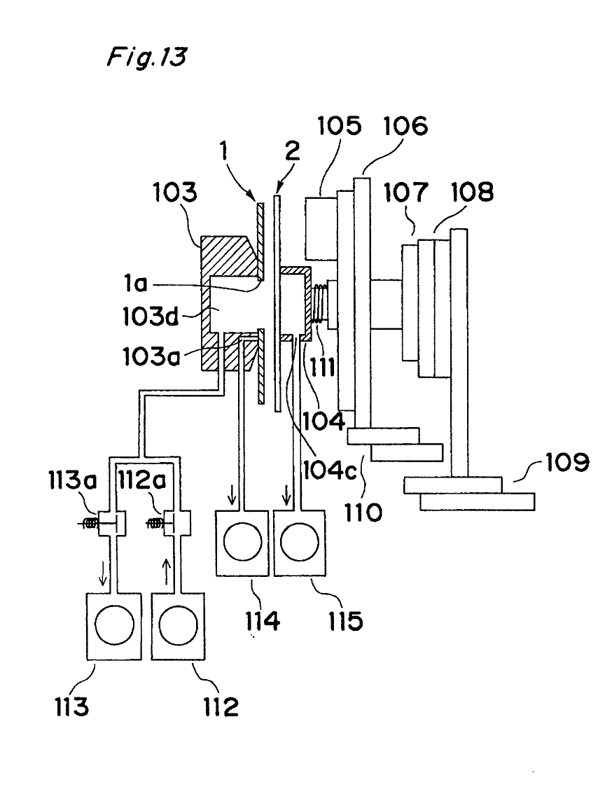

FIG. 13 shows another embodiment of the present invention similar to the embodiment of FIG. 7. In FIG. 13, there are shown various kinds of driving devices such as the rotary motor 106 for rotating the permanent magnet 105, the X-direction stage 107, the Y-direction stage 108, the linear slider 109, the linear slider 110.

In FIG, 13, reference numeral 111 denotes a spring, 112 denotes an air compressor, 112a denotes a pneumatic solenoid-controlled valve for air compressor corresponding to the pneumatic solenoid-controlled valve 9 in FIG. 5, 113 denotes a vacuum pump, 113a denotes a vacuum solenoid-controlled valve for the vacuum pump 113 corresponding to the vacuum solenoid-controlled valve 10 in FIG. 5, 114 denotes a vacuum pump, 115 denotes a vacuum pump. The spring 111 corresponds to the buffering structure (serving as one example of a buffering device) 17 in FIG. 7. The vacuum suction device 115 corresponds to the vacuum suction device 102 in FIG. 7. The vacuum suction device 114 corresponds to the vacuum suction device 101 in FIG. 7. The vacuum suction device 113 corresponds to the vacuum suction device 100. The stage .103 corresponds to the stage 20 in FIG. 7. Reference numeral 103a denotes a suction port corresponding to the suction port 20a in FIG. 7, 103d denotes an inner space corresponding to the inner space 20d in FIG. 7.

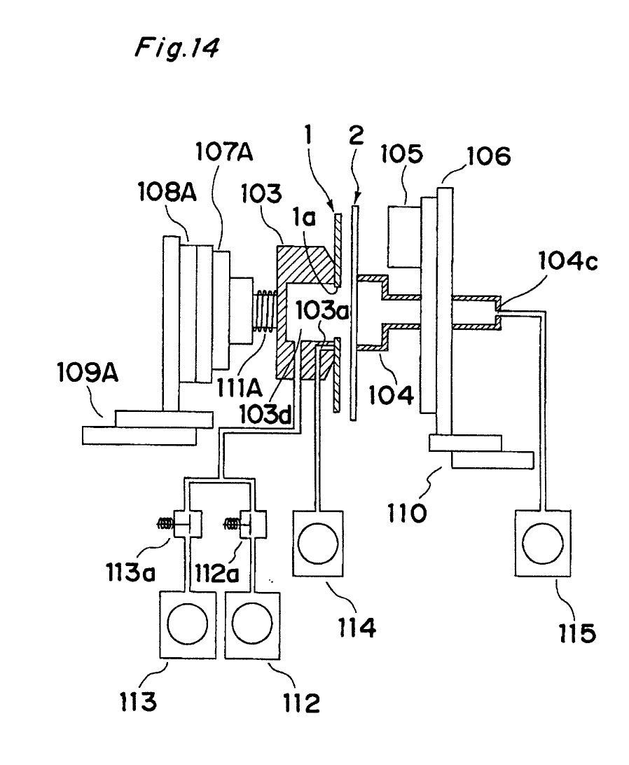

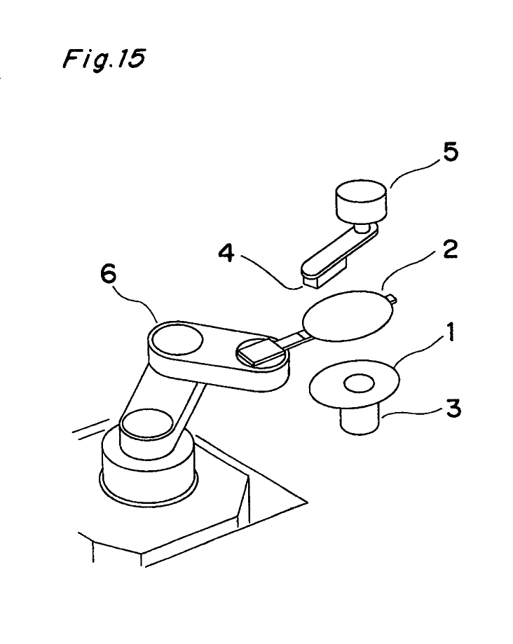

FIG. 14 is another embodiment of the present invention where the spring is located on the slave disk side as the buffering structure, whereas in FIG. 13, the spring is located on the master disk side as the buffering structure. In FIG. 14, reference numeral 107A denotes an X-direction stage for slave disk, 108A denotes a Y-direction stage for slave disk, 109A denotes a liner slider for slave disk, 111A denotes a spring. The X-direction stage 107A for slave disk is driven in a manner similar to the X-direction stage 107. The Y-direction stage 108A for slave disk is driven in a manner similar to the Y-direction stage 108. The liner slider for slave disk 109A is driven in a manner similar to the linear slider 109.

Although the magnetic signals including format information and address information etc. are transferred in the embodiments, data or software which are used for user may be also transferred in the same manner as the format information and address information etc.

According to the present invention as described above, a slave disk is put in close contact with a master disk through execution of vacuum adsorption. As a result, magnetic transfer from the master disk to the slave disk can be conducted with accuracy free from transfer irregularities. In addition, deformation of the master disk caused by vacuum suction-holding as well as failures at the time of detachment can be prevented. Further, there is provided a structure to prevent generation of damages when the master disk and the slave disk are put in close contact at a high speed, which enables reliable magnetic transfer with increased productivity.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A magnetic transfer method for performing magnetic transfer from a master disk having projections indicating information to be transferred to a slave disk with a center hole in a center thereof by placing the master disk and the slave disk in face-to-face close contact with each other,
the method comprising:
placing the master disk and the slave disk in face-to-face contact with each other;
conducting vacuum suction from the slave disk or the master disk for achieving close contact between the master disk and the slave disk facing each other;
magnetically transferring information recorded on the master disk to the slave disk; and
detaching the master disk and the slave disk after the magnetic transfer is terminated.

2. A magnetic transfer method as defined in claim 1, wherein in achieving close contact between the master disk and the slave disk, vacuum suction is also conducted so as to prevent deformation of a portion of the master disk confronting the center hole of the slave disk from a surface of the master disk opposite to a surface in close contact with the slave disk.

3. A magnetic transfer method as defined in claim 1, wherein upon contact or detachment of the slave disk and the master disk, gas is inserted toward the master disk through the center hole of the slave disk.

4. A magnetic transfer method as defined in claim 1, wherein the master disk is placed in face-to-face contact with the slave disk with a buffering operation of the master disk or the slave disk.

5. A magnetic transfer apparatus for performing magnetic transfer from a master disk to a slave disk with a center hole in a center thereof by placing the master disk and the slave disk in face-to-face close contact with each other, comprising:
a slave disk holding device for holding the slave disk;
a vacuum suction device for conducting vacuum suction between the master disk and the slave disk;
a master disk holding device for holding the master disk;
a forward and backward driving device for conducting forward and backward driving of at least either the slave disk holding device or the master disk holding device in a direction of coming the master disk and the slave disk in contact with each other; and
a magnetic transfer device for transferring magnetic signals recorded on the master disk to the slave disk.

6. A magnetic transfer apparatus as defined in claim 5, wherein the master disk holding device is provided with a suction device for vacuum-sucking a surface opposite to a surface in face-to-face contact with the slave disk.

7. A magnetic transfer apparatus as defined in claim 5, wherein the slave disk holding device is provided with a gas insertion device for inserting gas from the center hole of the slave disk toward the master disk.

8. A magnetic transfer apparatus as defined in claim 5, wherein the forward and backward driving device is provided with a buffering device for placing one of the master disk holding device and the slave disk holding device in face-to-face contact with the other thereof with a buffering operation.

9. A magnetic transfer apparatus as defined in claim 5, wherein the slave disk holding device is formed to be a cylindrical shape having an inner diameter larger than a diameter of the center hole of the slave disk, and a side thereof opposite to a side holding the slave disk is blocked by a transparent object.
